(19) United States
(12) Patent Application Publication
(10) Pub. No.: US 2008/0010171 A1
(43) Pub. Date: Jan. 10, 2008

(54) Method for distributing inventory information in a communication system

(76) Inventor: Tony T. Ghanma, Santa Clara, CA (US)

Correspondence Address: Kevin H. Fortin, Esq., 1061 Hickorynut Court, Sunnyvale, CA, 94087, US

(21) Appl. No.: 11/455,456

(22) Filed: Jun. 17, 2006

(51) Int. Cl. G06Q 10/00; G06Q 30/00

(52) U.S. Cl. 705/28; 705/26

(57) ABSTRACT

A method for using a click-thru interface to facilitate on-line sales of products and services. The method includes receiving inventory information from a plurality of distributors. The inventory information describes a number of products maintained by the distributors. A service provider in communication with the distributors maintains a core database and stores the inventory information in the core database. The service provider's core database communicates with resellers to enable the resellers to select a portion of the inventory information and compile the selected inventory information in an automatically updateable pull frame which is communicated to be displayed on a web page operated by the reseller. In this way a single pull frame can include inventory information from multiple distributors in a uniform format.

### FIELD OF THE INVENTION

The present invention includes a method for distributing inventory information and selling products among a plurality of distributors, resellers and customers, and particularly a method of click-thru sales via the Internet.

### BACKGROUND AND SUMMARY OF THE INVENTION

Online shopping over the Internet has evolved to now be a common part of the typical consumer's shopping pattern, and lifestyle.

Typically on-line shopping is done at a particular retail website, or a shopping portal, which sells goods from multiple retailers. The shopping portal owner may warehouse some products, and other products may be stored by a plurality of affiliated online shop owners. Conventional shopping portals such as Amazon.com™ and eBay™ serve as an interface for individual online shop owners to sell through the respective shopping portals.

eBay™, in particular has eBay Stores™ which enables reseller to sell products through “on-line auctions”, “fixed-price” listings, “store inventory format” listings. A customer browses the shopping portal and links to the on-line store may appear in auction search results, for example.

Amazon.com™ provides a web portal that lists inventory items offered for sale by Amazon.com™. When a shopper specifies a product, then links to sources of the product are displayed. These sources typically include Amazon.com™ itself and various Amazon.com™ Stores, which are individually owned.

Google.com™ provides refined way of linking customers with sellers of products. In particular, Google.com™ enables click-thru advertising, called Sponsored Links”, on search engine search results pages, on its Gmail™ email interface, and via its Froogle™ product search web interface. The web portal user simple need only go about his or her business and sponsored links with appear, which enable the user to click-thru to a product vendor's web site. The “sponsored links” do not appear at random, or in pre-assigned sequence. Instead, “sponsored links” automatically appear in order of relevance.

In the Google.com™ search engine, when the term “car”, for example, is searched, a “sponsored links” appears and shows click-thru advertising in text form relating to cars. This also works with the Gmail™ email program. Depending on the context of the email, particular “sponsored links” appear near the email text. These techniques of using context to display click-thru links is so effective that this has been used to benefit advertisers in the Google™ AdSense program, which allows web site owner to display click-through advertising. The AdSense program generates click-thru advertising based on the context of the web-site where it is presented. Accordingly, the relevance of the click-thru ad is always aligned with the context of the web site that the click-thru ad will appear. More revenue is generated for both the web site owner and for Google™.

Web site operators want to control the manner and configuration of click-thru and other advertising that appears on the vendors web site. Interestingly, the Google™ sponsored links may produce advertising links to web site that compete with the vendor's site. Links may appear that are contrary to the message of the vendor's web site. To address problems with content of the click-through links, various filters are offered to enable the vendor to prevent the display of click-through advertisements of selected competitors on the vendor's web site. Vendors take steps to implement and monitor these filters.

Resellers want to optimize logistics. For example, some shopping portals have drawbacks that particularly effect small-sized and medium-sized shop owners and resellers that rely on shopping portals for their livelihoods. Resellers typically maintain an inventory. Even though vendors and resellers are engaged in online sale of goods, they often need to invest in brick and mortar-style warehouses to store their goods. Optimal logistics planning, however, would limit the number of warehouse or distribution centers that are used under a shopping portal model in order to reduce inventory and shipping costs, which are typically passed along to the consumer.

Many resellers desire to outsource fulfillment. To illustrate, resellers need to handle order fulfillment, packaging and shipping, and payments. This is time consuming, as most small online retailers can attest. The fulfillment, packaging, and shipping steps associated with order delivery can limit the time an on-line entrepreneur can devote to business administration and customer service. It would be more efficient to have a more centralized logistics operation linking each of the online shop owners.

Online resellers desire repeat business and customer loyalty. Many shopping portals including Amazon.com™ and eBay.com™ achieve customer loyalty, however, the individual shop owners and small retailers that rely on these shopping portals may fail to obtain trade-name recognition and consequential customer loyalty. Simply stated, the present situation with online shopping portals does not lend itself to maximizing customer loyalty to the small-sized and medium-sized on-line shop owners. Accordingly, while the typical shopping portal undoubtedly benefits from the growth of online shopping trends, the small online resellers have limited opportunity to grow their individual businesses though customer loyalty and name recognition.

Many web site owners are neither vendors, nor resellers, but they still need revenue. There are many useful association, club, library, search engine, email systems, and commercial and non-commercial web sites. Many of these useful sites have click-thru advertising, which generates revenue. Revenue is generated when useful site owner is paid incremental amount due to the re-routing of web traffic via a click-thru advertisement. This has worked for years as a business model and software for click-thru advertising is readily available. One drawback with click-thru advertising is that the web site owner sends the user of the web-site owner's site to other sites. Additionally, customers may desire to buy goods directly from a known and trusted web-site, without being re-directed to a click-through web-site of an unknown vendor. Furthermore, the web-site owner could improve revenue by retaining and serving the customer directly, instead of realizing a gain of only a fraction of a cent from each use of the click-through advertising.

Hence, there exists a need for systems and methods that enable a web-site owner to sell a variety of products to its customers. There is also a need to improve logistics, and administration of on-line selling while serving one's customers with improved depth and lower prices.

The present invention provides a way of enabling a web-site owner to sell a plurality of selected product directly to customers, who would otherwise be re-routed via a click-thru advertisement. The present invention also provides a way to achieve customer loyalty and sell products with minimum attention, skill and cost. The present invention may also improve the efficiency of order fulfillment and logistics, which can save costs for the customer.

Accordingly, one aspect of the invention includes a method implemented by a service provider's core database, which tracks, electronically communicates, and automatically updates inventory information to resellers (i.e. on-line shop owners). Distributors remain anonymous and may sell inventory by simply posting the items for sale on a service provider's core database. Resellers select inventory information according to their business needs and without the distributors being identified. The resellers are better able to serve their loyal customers because fulfillment and logistics burdens are minimized by the present invention. Distributors can maintain numerous distribution channels by virtue of the numerous reseller web sites, without having to pay for excessive advertising and sales expenses.

The system of the present invention enables distributors to post their inventory into a service provider's database and to enable resellers to selectively “pull” items to be posted on their own web-site for the purpose of resale. Important transaction information is communicated to the distributors via the service provider's transaction database to satisfy payment and logistic needs of the sale and pay the resellers agreed upon fees and commissions.

One method in accordance with the present invention enables distributors to sell inventory by posting items for sale on the service provider's core database. The distributors include a set of dealers placing the inventory information in the service provider's core database. The resellers include a set of dealers or shop-owners that are enabled to “pull” and display the inventory information from the service provider's database. The customers include individuals, dealers, or the like, that select items based on the inventory information and purchase the items from the resellers.

Another method distributes inventory information and enables a reseller to sell products of a plurality of distributors to a customer. The method includes receiving inventory information from a plurality of distributors. The inventory information describes a number of products maintained by the distributors. The inventory information identifies the product to be sold, price, quantity available, and may also include images, video and textual specifications. A service provider in communication with the distributors maintains a core database and stores the inventory information in the core database. Preferably the service provider specifies a presentation format, categorization, and provides pre-filled templates to ease selection of inventory information by resellers.

The core database communicates with resellers to enable the resellers to select a portion, or all, of the inventory information and compile the selected inventory information in a pull frame that is communicated to be displayed on a web page operated by the reseller. In this way the reseller need not recreate the inventory information, but may use the format that the core database enables. According to one aspect of the invention, the process of pulling inventory information to the reseller web site is automated in software using pre-defined templates and where the reseller only need to choose the item to be sold and set the price. In an alternate embodiment, the templates have various levels of detail and the reseller may select the desired level of detail.

A single pull frame may include inventory information from multiple distributors because it is pulled from the core database, which communicates with multiple distributors. The service provider also maintains and communicates a transaction module interface to resellers to enable the financial aspects of any purchase of products. When the reseller receives a customer order in response to the display of the inventory information, the transaction module requests the relevant distributor to ship products in response to the customer order.

Upon acceptance of the order the transaction module enables payment and enables the customer to directly compensate the distributor for selling and shipping products. The reseller need not be informed of, or know, the identity of any such distributor, or distributors.

There are several ways to compensate the distributors, resellers and service provider. One way requires the distributors to ship products in response to the customer order and the distributor is compensated directly by the customer. Another way is to compensate the service provider directly and the service provider shares a portion of the compensation with the distributor and with reseller. Payment to the reseller may include commissions paid by the distributor, or by the service provider, after the products are shipped. Other methods include the customer having a multi-furcated transaction. For example, the customer may have a trifurcated transaction where the customer makes one payment that is automatically trifurcated to directly allocate amounts owed and then compensate the service provider, the distributor and the reseller via the transaction module. A variation of this payment method includes where the customer pays the distributor who then compensates the resellers after the product is delivered. Alternatively, the customer can compensate the service provider who then compensates the distributor and the reseller.

The present invention allows distributors to sell inventory by posting the items for sale on a service provider's core database while resellers sell products via a pop-up box, or the like, having an integrated transaction capability. The reseller need apply an amount of effort comparable to that of setting-up and monitoring click-thru advertising. In this way resellers simple choose items to sell from the core database and need not deal with inventory, fulfillment, logistics and payments.

Another advantage of the present invention is to provide a system and a method for allowing any in a network of resellers to display the total available quantity for sale, as posted in the core database by any of a number of distributors.

Another advantage of the present invention is to provide a system and a method to expand the ability of a distributor to sell a particular quantity of single items at an extremely rapid rate by displaying the same items simultaneously on multiple reseller websites.

Another advantage of the present invention is to provide a system and a method to allow resellers to get compensated for just displaying the chosen items on their website without requiring the reseller to engage in inventory maintenance, transaction processing, or fulfillment and logistics.

The above summary of the present invention is not intended to describe every embodiment of the present invention. The figures and detailed description that follow provide additional aspects of the present invention. The invention as a whole is defined by the appended claims.

### DESCRIPTION OF DRAWINGS

FIG. 1 is a diagram illustrating an embodiment of the system for managing and distributing inventory information and selling of identified items among a plurality of identified distributors, resellers and customers through a service provider.

FIG. 2 is a flow chart illustrating the distributor's signup process and posting of inventory information into the service provider's core database.

FIG. 3 is a flow chart illustrating the signup process for resellers into the service provider's core database.

FIG. 4 is a flow chart illustrating the process of “pulling” selected inventory information from the service provider's core database and displaying them on the reseller's websites.

FIG. 5 is a flow chart illustrating the customer's purchase process from the reseller's website in accordance with one aspect of the invention.

FIG. 6 is a flow chart further illustrating the customer's purchase process from the reseller's website.

FIG. 7 is a flow chart illustrating a method in accordance with the present invention.

### DETAILED DESCRIPTION

The present invention includes methods, systems, and variants thereof that enable the efficient distribution of inventory to customers. Particularly, the invention distributes inventory information among a plurality of identified distributors, resellers and customers through a service provider over a communication network. In the following description, numerous concepts and particular details are set forth in order to provide a more thorough understanding of the present invention. However, it will be apparent to one skilled in the art that the present invention may be practiced without many such specific details. Also, some well-known features have not been described in detail in order to avoid obscuring the present invention.

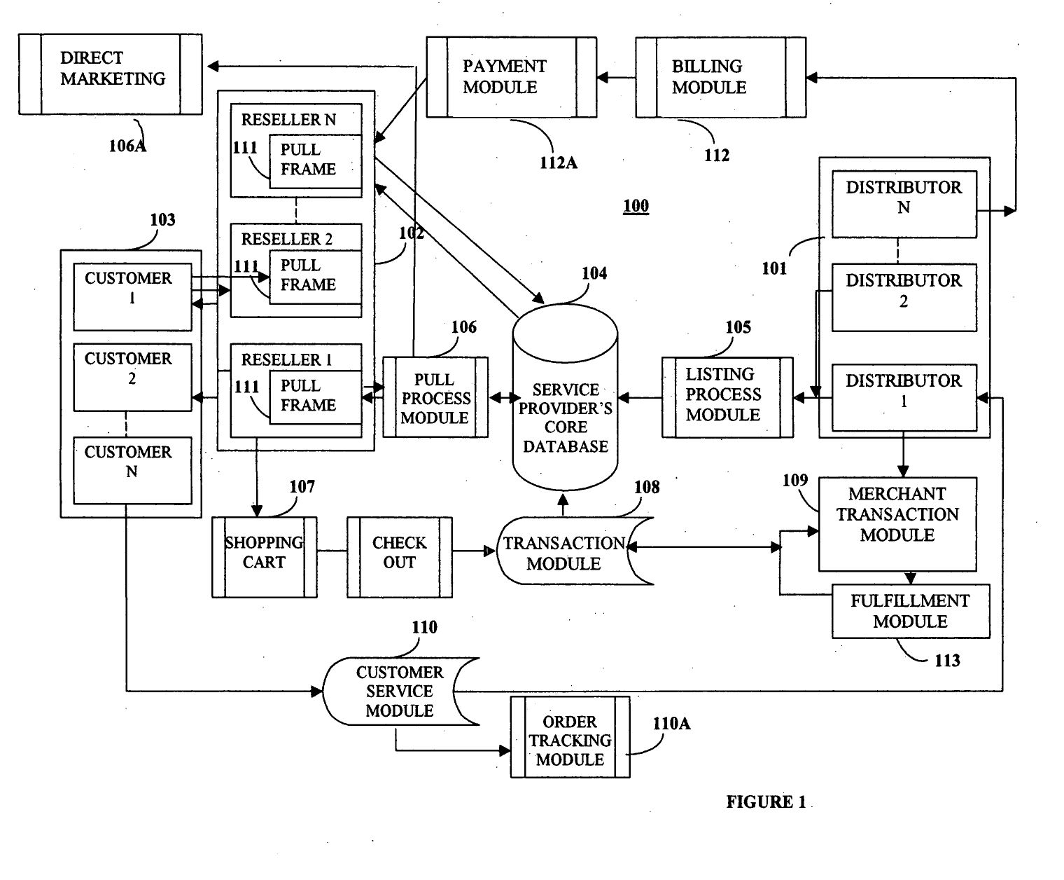

FIG. 1 illustrates one embodiment of a system 100 for managing and distributing inventory information and selling products. According to one aspect of the invention, the system 100 includes a service provider server having a transaction module 108 and a pull process module 106. The transaction module 108 includes an integrated merchant transaction module 109 and fulfillment module 113. The merchant transaction module 109 and fulfillment module 113 are discrete modules, but it can be appreciated that they may be designed to be integrated.

The system 100 distributes products among a plurality of distributors 101, resellers 102 and customers 103. An interactive communication is enabled between the plurality of identified distributors 101, resellers 102 and customers 103 through a service provider core database 104. The distributors 101 sign up into the service provider's core database 104 and post inventory information through a signup window on the service provider's website. Inventory information includes pricing and availability information. Inventory information also includes product details, including images, specifications, testimonials, advertising slogans, trademarks, and other information useful to a customer. The listing process module 105 ensures that adapts product-dependent fields for posting the inventory information. The core database 104 communicates with a distributor server to upload inventory information from the distributor 101 to the service provider's core database 104.

The pull process module 106 of the core database 104 communicates with reseller servers to enable resellers 102 log in to the core database 104. The core database 104 displays a reseller's management window to allow the resellers 102 to browse, search, advanced search, preset viewing options, save searches, or save categories and subcategories, select an product or set of products having associated inventory information. The reseller management window also allows the resellers 102 to edit the price of the product and to re-organize the products in categories and sub categories. The core database 104 enables resellers 102 to preview exactly how the pull frame 111 contains the inventory information. The core database 104 enables the resellers 102 to preview the inventory information to see how it would look on the reseller's website. Thus, each reseller 102 can select and pull the inventory information from the service provider's core database 104 to display the inventory information on their websites.

The pull process module 106 also enables resellers 102, without the direction of a customer, to purchase products from the distributors to facilitate direct marketing 106A of the inventory they selected from the service provider's database 104.

There are at least two ways of pulling the inventory information from the service provider's website. According to one aspect of the invention the resellers 102 select the inventory information of interest in the form of a pull frame 111 from the service provider's web site. The pull frame 111 is automatically formatted for use on the reseller's websites. Alternatively, the pull frame 111 is generated with extensible markup language (XML) or NET code to enable placement of the pull frame 111 on a resellers web site with minimum of modification. The pull-frame can replace click-thru advertising on resellers web sites to enable resellers to gain customer-recognition and to realize improved revenue.

The pull frame 111 has a consolidation resource having a shopping cart 107, which is programmed as part of the transaction module 108. Customers consummate transactions directly with the resellers through the consolidation resource. The consolidation resource integrates the financial aspects of purchases of reseller inventory with the purchases of distributor-held inventory as reflected by the inventory information and then bifurcates any customer-initiated payment to the reseller and distributors in proportion to the value of goods that were sold. The customers 103 view and purchase the products on the reseller's website through the transaction module 108. The pull frame 111 communicates purchase and customer information to the transaction module 108. The customers 103 select the quantity of a product to be purchased and add it to the shopping cart 107 on the reseller's website.

The transaction module 108 is automatically updated. Particularly, the transaction module 108 performs administrative approvals including polling distributors to verify that the products to be sold are still in inventory and that the price and availability are correct. The distributor issues a confirmation via the transaction module 108 and via the service provider core database 104 to the reseller. Once administrative approval is confirmed, the quantity of products to be sold is updated in the service provider core database 104. The functions of the transaction module 108 include approving the customer purchase of the selected products, informing all parties (distributors 101, resellers 102 and customers 103) about the transaction and allowing the resellers 102 and distributors 101 to have the transaction information as history. Transaction information is electronically sent to distributors 101, e.g. via email, and remains available through a distributor sales management window of the core database 104. Distributors 101 and resellers 102 access the core database 104 to track shipped products.

The fulfillment module 113 communicates with fulfillment centers, which perform numerous functions. The distributors 101 can either ship the products purchased by the customers 103 directly to the customers 103.

In an alternate embodiment, distributors 101 ship first to a fulfillment center operated by the service provider where shipments are consolidated for re-shipment to a customer 103.

Customers 103 are able to purchase the reseller's stocked products from the reseller web-site and distributors inventory, which is stocked by the distributor. The customer 103 can make a single payment for both the purchases. Either the fulfillment module 113, or the transaction module 108, or both, manipulates the transaction and divides the payment among respective distributors 101 and resellers 102 involved in the transaction. The financial information along with shipping information gets transmitted to the distributor's web based transaction 108 module, waits for approval, and sends back the approval code to the transaction database, completing the transaction.

The customers 103 are billed subsequent to purchase of the product displayed on the reseller's website 109. All products in the inventory will have a price given by the distributor 101. According to one aspect of the invention, the resellers 102 choose and assign an appropriate price for each product and publish the price of each product. The distributor 101 compensates the reseller 102 for the price mark-up in addition to compensating the reseller in the form of a commission.

There is a customer service module 110 to assist the customers 103 at any stage of purchase. The customer service module 110 is connected with the order-tracking module 110a that keeps track of orders. The distributors 101 send billing information through the billing module 112 and billing information is sent to resellers through the payment module 112a.

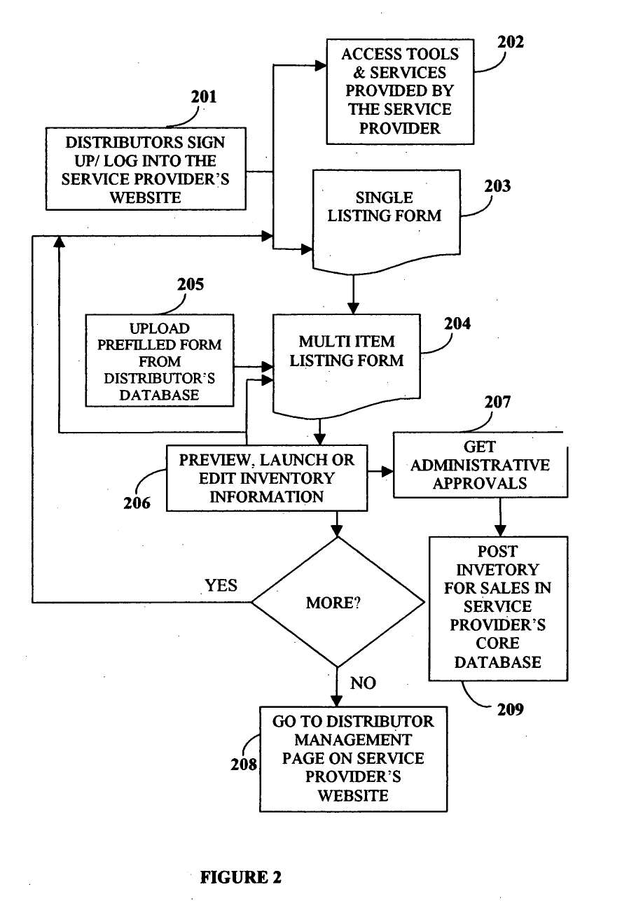

FIG. 2 is a flow chart illustrating the signup process for distributors 101 and posting of inventory information into the core database 104 of the service provider. All distributors 101 are pre-qualified to post inventory on the service provider's core database 104, and must satisfy the qualification conditions set by the service provider. Such qualification conditions include specific geographical location, size of distributor and the volume of predicted sales in a month. The distributors 101 fill the inventory posting forms and post the inventory information into the service provider's s core database 104, 201. These inventory-posting forms are set to accept a single inventory product 203 or multiple posting of inventory products 204 according to the distributor's choice.

Pre-filled inventory posting forms can be uploaded directly from the distributor's website 205. Pre-filled inventory posting forms include the existing product descriptions from the distributors's websites or it can also be a block of pre-filled forms (a list) or a picture-linked to a pull frame 111. Some of the sample fields in the inventory posting forms include title of the product, description of the product, quantity available for the sale of the product etc. Additional services such as transaction processing, logistics and fulfillment center abilities are also available.

The tools services available to the distributors 101 at the time of signing up include reporting, invoice and packing slip printing, automatic notifications for customers 103 and resellers 102, history of completed transaction and price check of comparables 202. After the administrative checks are completed, the inventory information is approved to be uploaded 207. Then the inventory information is uploaded in the service provider's core database 104, 209. The distributors 101 are able to preview and edit the inventory information 206. Distributors 101 are prompted to add more inventory information Each distributor 101 has its own management page in the service provider's website. If the distributors 101 opt to terminate adding the inventories, they will be taken back to the distributor management page on the service provider's website 208.

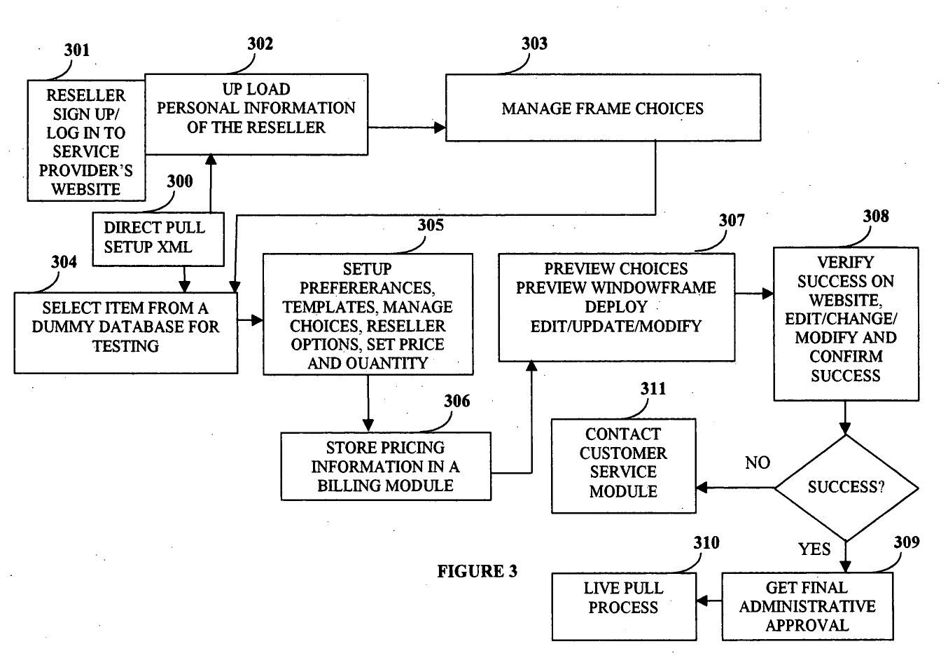

FIG. 3 is a flow chart illustrating the signup process for resellers 102 into the service provider's core database 104 for selectively displaying inventory information on the reseller's websites. The resellers 102 signup into the service provider's core database 104 to enable an interactive communication and to pull inventory information 301. The resellers 102 upload their personal information and also make use of side menus for help and demonstration 302. The tools available to the resellers 102 at this stage include transaction history, current and past inventories, saved searches and categories (sub categories), favorite distributors, product management (edit, cancel, update, and scheduling), tracking, communication with distributors and dispute resolution.

The resellers 102 choose pull frame 111 format options. The various pull frame 111 options include side frame, window frame, full-page frame, front page, full-page frame, non-front page with link to front page and a picture linked to a pull frame. A full page frame will have a full page window with only reseller's page header and the rest of the window having service provider's pull frame 111. Further resellers 102 can select any size of pull frames 111 according to their choice and modify their websites. A pull frame 111 can be the same size as a typical click-thru box.

The resellers 102 confirm their success on the website 308 and after final administrative approvals 309 they pull the inventory information 310 from the service provider's website. Resellers 102 can directly pull the inventory information (product description) through XML 300. When the reseller 102 pulls the inventory information from the service provider's core database 104, the selected product description gets pulled out through XML directly and gets transformed into the reseller's websites. This allows the resellers 102 to present any chosen products to be displayed on their own website for the purpose of resale without having an inventory or need to handle logistics or payments. At the verification stage, resellers 102 can edit or modify product information. If the resellers 102 are not successful in the pull process, the customer service module 112, 311 assists them.

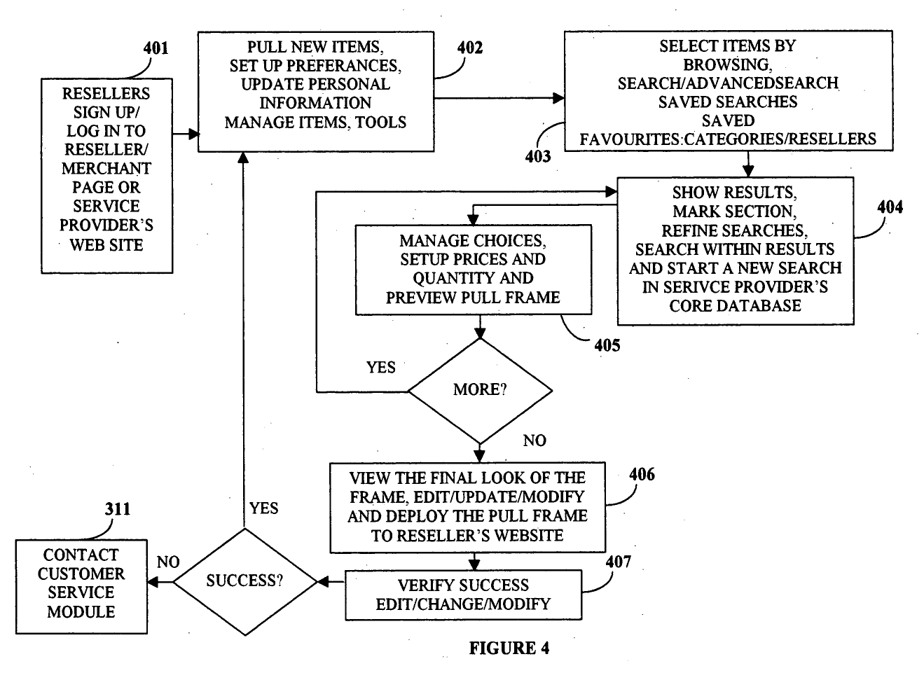

FIG. 4 is a flow chart illustrating the process of “pulling” selected inventory information from the service provider's core database 104 and displaying them on the reseller's websites. Resellers 102 sign in to the service provider's website 401. The service provider's sign in window includes the options for pulling new products, preferences, updating personal information of the resellers 102, managing products and tools 402. Resellers 102 have the following facilities for searching a new product namely, browse, search and advanced search, saved searches, saved favorites 403. Also, they can search within the search results, start new searches and view the results 404.

Resellers select products from the service provider's core database 104, and price the selected products 405. Resellers 102 are able to view exactly how the pull frame 111 would look on the reseller's website and deploy the pull frame 111 to their own website 406. After editing, updating or modifying the final information, resellers 102 confirm their success and go back to the service provider's home page 407.

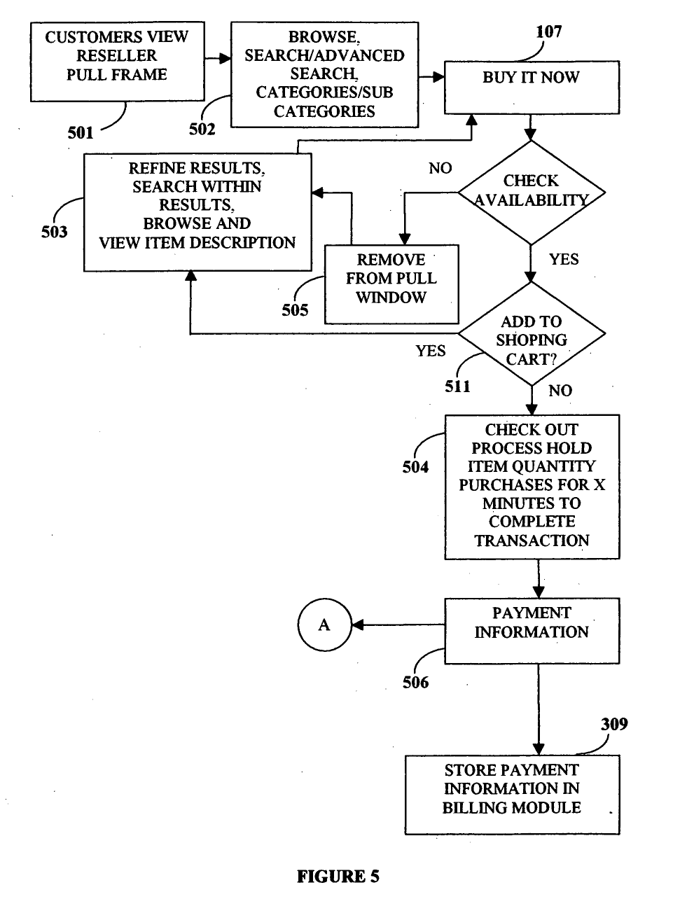

FIG. 5 is a flow chart illustrating the customer's purchase process from a reseller's website. The customers 103 view the reseller's pull frame 111, which contains the selected inventory products available for sale 501. Customers 103 have the following facilities for searching a new product namely, browse, search and advanced search 502. They can also refine search, search within the results and view the product description 503. Following the selection of a product, customers 103 have the option to buy products 107. If the customer 103 opts to buy a product, availability of the selected product is checked from the service provider's core database 104. If the product is available, customers 103 are asked whether they want to shop more and add to the shopping cart 511. If customers 103 opt to stop select a new product, they are taken to the home page to browse for more new products 503. If the product being selected is not available, the product description is removed from the reseller's pull window 505.

The quantity being purchased by the customers 103 is checked out and put on hold for a predetermined number of minutes, to allow the customers 103 to complete the transaction 504. In an alternate embodiment the hold is placed while the customer engages in continuous shopping activity continues on the reseller web site. The payment information 506 is submitted to the distributors 101 for approval 507. This payment information is stored in the billing module 309.

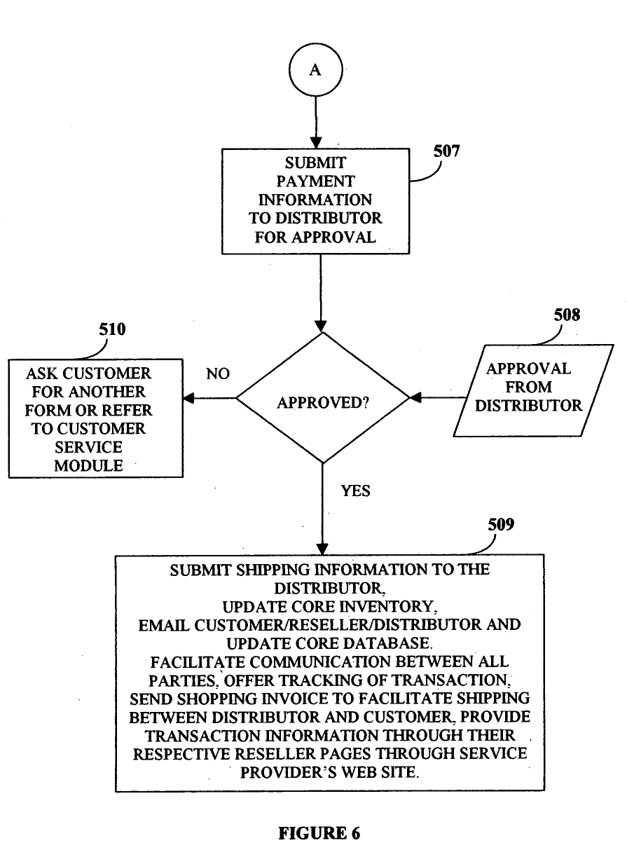

In FIG. 6, shipping information is submitted to the distributors 101 after the purchase is approved from the distributors 101, 508. Distributors 101 send the product purchased directly to the customers 103. Alternatively products purchased may be sent trough the service provider's global fulfillment centers. The product being shipped to the customers 103 will have the reseller's name label on the product so that the product can be shipped successfully to the respective customers. The transaction module 108 provides the information to print the reseller's name on the label.

The service provider's core database 104 is updated and notification is sent to the customers 103, resellers 102 and distributors 101, 509. The shopping invoice of the purchase is sent back to the distributor 101 to facilitate shipping between distributors 101 and customers 103. The service provider facilitates communication between all parties (distributors 101, resellers 102 and customers 103) and offers tracking information of the transaction. Also, transaction information is provided through their respective reseller pages through service provider's web sites. If the purchase is not approved, customers 103 are asked for another form or they are asked to contact customer service module 510.

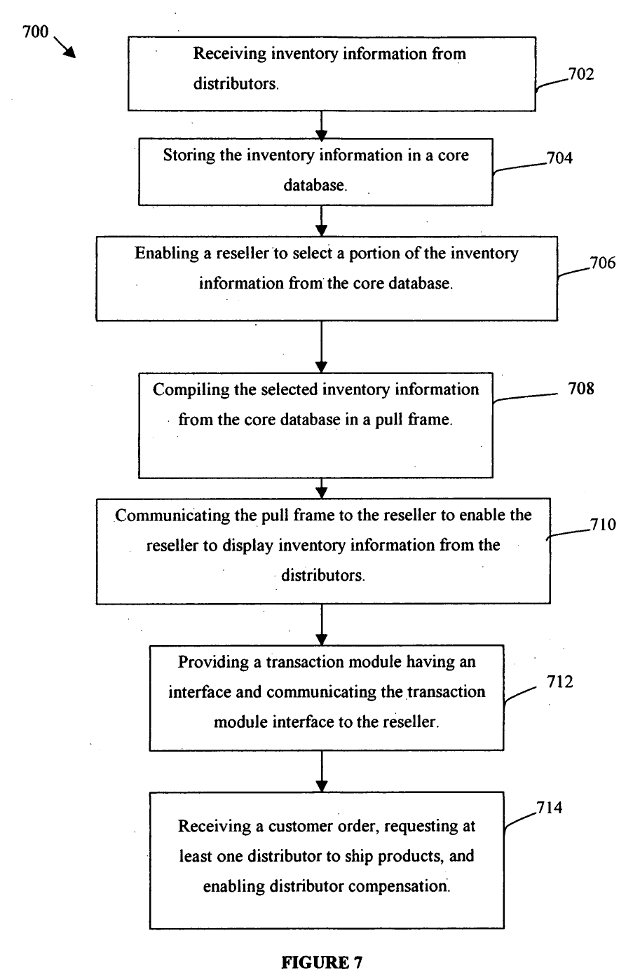

FIG. 7 is a flowchart including a method 700 for distributing inventory information from distributors. The method 700 includes the step 702 of receiving inventory information from distributors, the step 704 of storing the inventory information in a core database, the step 706 of enabling a reseller to select a portion of the inventory information from the core database, the step 708 of compiling the selected inventory information from the core database in a pull frame, the step 710 communicating the pull frame to the reseller to enable the reseller to display inventory information from the distributors, the step 712 of providing a transaction module having an interface and communicating the transaction module interface to the reseller, and the step 714 of receiving a customer order, requesting at least one distributor to ship products, and enabling the customer to compensate the distributor

A service provider having a core database 104 performs the step 702 of receiving inventory information from distributors. The inventory information describes inventory maintained by more than one of the plurality of distributors and describes any of a number of products.

The step 704 stores the inventory information in the core database. Optimally the distributors will have pre-formatted inventory information designed (i.e. packaged) for distribution to numerous reseller web sites. Inventory information typically includes a descriptive image of the product, text describing the product specifications, and advertising text and images, or a hyperlink to such information. Thumbnail descriptions and hyperlinks can be used, for example. According to one aspect of the invention, the inventory information includes video and audio format information, or a thumbnail image and a hyperlink to such information.

According to one aspect of the method 700, the inventory information originates from a plurality of distributors, having a plurality of formats. A reseller selects particular inventory information from the core database relating to a particular product line, with the intention to ultimately post the inventory information to the reseller's web page. This inventory information can be posted in the form of a pull frame, or otherwise. The service provider provides inventory information reformatting software on a service provider web-site for use by the reseller. The reseller uses the reformatting software to reformat the inventory information prior to posting the inventory information on the resellers web site. The step 706 of enabling a reseller to select a portion of the inventory information includes enabling the reseller to automatically reformat the inventory information to a consistent format. The step 706 enables resellers to automatically display products from of a plurality of distributors in a uniform format. Resellers need not maintain inventory.

In an alternative embodiment, the service provider automatically formats the inventory information accordingly to a pre-determined template. Alternatively, the reseller reformats the inventory information, or the already-formatted inventory information, in a custom way as the reseller chooses.

The step 708 of compiling the selected inventory information from the core database is accomplished by formatting the inventory information in a pull frame format. A pull frame format can be readily identified, selected and communicated to a reseller. Typically a pull frame can be rapidly, or automatically integrated into a reseller web-site. Types of pull frames include automatic pop-up windows, temporary windows, and permanently integrated frames in a web page.

The step 710 of communicating the pull frame to a reseller enables the reseller to display inventory information from any of a number of distributors. In this way the inventory information is displayed. The distributor name and address are not displayed.

The step 712 provides a transaction module interface to a reseller to enable the purchase of products. The transaction module includes a shopping cart interface.

The step 714 includes receiving a customer order through the transaction module interface of the reseller web page. The customer order is in response to the display of relevant inventory information on that reseller web page. After the order is received, the reseller requests at least one distributor to ship products in response to the customer order. The service provider transaction module enables the customer to compensate the distributor for selling and shipping products.

According to one aspect of the invention, the service provider transaction module also enables the customer to compensate the service provider. It can be appreciated that any transaction made via the transaction module can be bifurcated to automatically pay the service provider and the distributor. Payment to the service provider and distributors is simultaneously made in accordance with one aspect of the invention.

Alternatively, the transaction module directly compensates the distributor who, in turn, compensates the service provider with a portion of the receipts of any transaction, and pays a commission to the reseller. On some occasions there are several, or a plurality of distributors, so compensating the distributor includes compensating many distributors for a single order made by a customer.

The step 714 includes shipping products in response to the customer order and sharing a portion of the compensation with the reseller in the form of commissions after the products are shipped. Preferably, the reseller is compensated 30 days after the product is shipped.

According to one aspect of the invention, the step 714 enables the customer to compensate the service provider directly. Once the customer compensates the service provider directly, the service provider will, in turn, compensate the distributor and pay a commission to the reseller.

While the present invention is disclosed in terms of exemplary embodiments, it can be appreciated that the methods of the present invention can be practiced in a number of ways as defined by the scope of the appended claims. Additionally various features of the system of the present invention can be modified in myriad of ways to achieve the goals of the invention, which includes having a single financial transaction from a customer to more than one distributor.

1. A method for communicating inventory information from distributors to resellers and customers via a service provider over a communication network, comprising:
receiving inventory information from distributors, said inventory information describing any of a number of products and storing the inventory information in a core database;
enabling a reseller to select a portion of the inventory information from the core database;
compiling the selected inventory information from the core database in a pull frame;
communicating the pull frame to the reseller to enable the reseller to display the selected inventory information;
automatically updating the selected inventory information;
providing a transaction module having an interface, and
communicating the transaction module interface to the reseller to enable customers to purchase products through the transaction module interface.

2. A method as set forth in claim 1, wherein the transaction module interface is integrated within the pull frame and the transaction module shields distributor identity from the pull frame.

3. A method as set forth in claim 3, wherein the transaction module enables a customer to purchase products from the reseller via the pull frame and the transaction module gathers customer information, including customer address and product description and quantity, the transaction module shares enough of the customer information with the distributors to enable the distributors to ship the purchased product to the customer.

4. A method as set forth in claim 3, wherein the customer purchases products from a number of distributors via the pull frame, the distributors independently ship the purchased product.

5. A method as set forth in claim 4, wherein the transaction module records sales from resellers and communicates the sales to the service provider to enable payment of reseller commissions from the service provider after distributors ship the purchased product.

6. A method as set forth in claim 5, wherein the transaction module enables the customer to directly pay the service provider and distributors in a single transaction.

7. A method as set forth in claim 6, wherein the transaction module enables the customer to directly pay the service provider and distributors in a single transaction and the identity of the distributors is not displayed to the customer before the payment has been made.

8. A method for distributing inventory information to enable a reseller to sell products from a plurality of distributors to a customer, comprising:
receiving inventory information from a plurality of distributors, said inventory information describing inventory maintained by more than one of the plurality of distributors and describing any of a number of products;
storing the inventory information in a core database;
selecting a portion of the inventory information from the core database and compiling the selected inventory information from the core database in a pull frame;
communicating the pull frame to a reseller to enable the reseller to display inventory information from any of a number of distributors; and
communicating a transaction module interface to a reseller to enable the purchase of products;
receiving a customer order in response to the display of the inventory information and requesting at least one distributor to ship products in response to the customer order;
enabling the customer to compensate the distributor for selling and shipping products; and
shipping products in response to the, customer order and sharing a portion of the compensation with the reseller in the form a commission after the products are shipped.

9. A method as set forth in claim 8, wherein a service provider operates the core database, and the step of enabling the customer to compensate the distributor includes directly compensating the service provider, thus enabling the service provider to compensate the distributor and the reseller.

10. A method as set forth in claim. 8, wherein the step of enabling the customer to compensate the distributor for selling and shipping products includes simultaneously compensating the distributor and the service provider in a bifurcated transaction.

11. A method as set forth in claim 8, wherein the step of enabling the customer to compensate the distributor for selling and shipping products includes directly compensating a plurality of distributors in a furcated transaction.

12. A method as set forth in claim 8, wherein the step of receiving a customer order in response to the display of the inventory information includes requesting a plurality of distributors to ship products in response to the customer order; and the step of enabling the customer to compensate the distributor for selling and shipping products includes directly compensating a plurality of distributors in a furcated transaction.

13. A method as set forth in claim 12, wherein a service provider operates the core database and the plurality of distributors independently share a portion of the compensation with the service provider and the service provider and the service provider compensates the reseller.

14. A method for distributing inventory information and enabling a reseller to sell products from a plurality of distributors to a customer, comprising:
receiving inventory information from a plurality of distributors, said inventory information describing inventory maintained by more than one of the plurality of distributors and describing any of a number of products;
storing the inventory information in a core database;
selecting a portion of the inventory information from the core database and compiling the selected inventory information from the core database in a pull frame having a pre-defined format;
communicating the pull frame to a reseller to enable the reseller to display inventory information from any of a number of distributors; and
communicating a transaction module interface to a reseller to enable the purchase of products;
receiving a customer order in response to the display of the inventory information and requesting more than one distributor to ship products in response to the customer order, and
enabling the customer to compensate the distributors for selling and shipping products in a single transaction

15. A method as set forth in claim 14, wherein a service provider operates the core database, and the step of enabling the customer to compensate the distributor includes simultaneously compensating the service provider.

16. A method as set forth in claim 14, wherein the step of enabling the customer to compensate the distributor for selling and shipping products includes simultaneously compensating the distributor and the service provider, and thus enabling the service provider to compensate the reseller after product is shipped from the distributor to the customer.

17. A method as set forth in claim 14, wherein the step of enabling the customer to compensate the distributors for selling and shipping products includes directly compensating a plurality of distributors.

18. A method as set forth in claim 14, wherein the step of receiving a customer order in response to the display of the inventory information includes requesting a plurality of distributors to ship products in response to the customer order; and the step of enabling the customer to compensate the distributor for selling and shipping products includes directly compensating a plurality of distributors; and the plurality of distributors each independently share a portion of their compensation with the reseller in the form of a commission.

19. A method as set forth in claim 18, wherein a service provider operates the core database and the plurality of distributors independently share a portion of the compensation with the service provider.

20. A method as set forth in claim 18, wherein the reseller sells products at a mark-up and the distributor compensates the reseller for the mark-up in addition to compensating the reseller in the form of a commission.
